(19) United States
(12) Patent Application Publication
(10) Pub. No.: US 2012/0128856 A1
(43) Pub. Date: May 24, 2012

(54) MAITAKE MUSHROOM COFFEE

(75) Inventors: Kazunori Kameyama, Middletown, NY (US); Ming Tsai, Wellesley, MA (US); Jeffrey Waskiewicz, Hadley, MA (US)

(73) Assignees: Ming East-West, LLC, Wellesley, MA (US); Yukiguni Maitake Co., Ltd., Niigata (JP)

(21) Appl. No.: 13/388,222

(22) PCT Filed: Jul. 30, 2010
(86) PCT No.: PCT/US2010/043836

§ 371 Date: Jan. 31, 2012

Related U.S. Application Data
(60) Provisional application No. 61/230,290, filed on Jul. 31, 2009.

(51) Int. Cl. A23F 5/00

(52) U.S. Cl. 426/595

(57) ABSTRACT

A method of producing a beverage including: combining roasted, ground maitake mushroom with roasted, ground coffee beans to provide a maitake-coffee mixture, and brewing the maitake-coffee mixture; and a maitake-coffee beverage produced thereby.

### BACKGROUND OF THE INVENTION

1. Field of the Invention

The present invention relates to a coffee-based drink containing maitake mushroom and a method of making said coffee.

2. Description of the Related Art

“Maitake” (Grifola frondosa) is a mushroom, which has traditionally been ingested as a food in Japan, and has been proven to be safe to eat, and known to contain immunopotentiating substances. The underground tubers from which maitake mushrooms arise have been used in traditional Chinese and Japanese medicine to enhance the immune system. Research has indicated that whole maitake has the ability to regulate blood pressure, glucose, insulin, and both serum and liver lipids, such as cholesterol, triglycerides, and phospholipids, and may also be useful for weight loss. In addition, maitake mushroom can be ingested to aid digestion and stomach ailments by regulating the stomach and intestines.

Furthermore, maitake mushroom extract has been used in cancer prevention and treatment due to its believed ability to regulate effector cells such as macrophages, killer cells, T cells, NK cells, interleukin-1 and superoxide anions.

Maitake is also rich in minerals (such as potassium, calcium, and magnesium), various vitamins (B2, D2 and Niacin), fibers and amino acids. The active constituent in maitake mushrooms associated with enhancing immune activity has been identified as the protein-bound polysaccharide compound, beta-glucan.

Previously, one could enjoy the benefits of maitake mushroom by ingesting the maitake in supplement form (i.e., extracts), in teas made from dried maitake, and by merely eating the intact (raw) mushrooms.

Processes for producing maitake extract comprise numerous steps including extracting Grifola with hot water, concentrating the extract under reduced pressure, precipitating the concentrate with an organic solvent, dialyzing the precipitates to remove low molecular weight substances, and extracting impurities with a lipophilic organic solvent. Such processes are not necessarily appropriate for providing a large amount of health foods efficiently from limited resources because their purification steps are considerably complicated and the products can contain substances that inhibit the desired immunopotentiating activity.

While preparing teas made from dried maitake or preparing meals including raw maitake is an alternative to using maitake extract, such preparation and ingestion would be in addition to one's daily routine and food/drink intake.

In view of the foregoing, the present inventors have discovered a way in which a person can consume enough maitake mushroom for obtaining the desired immunopotentiating activity without the need to supplement one's average daily food/drink intake and without the need of complicated and costly extract techniques associated with the use of maitake extract.

### SUMMARY OF THE INVENTION

The present inventors have discovered that by combining ground dried maitake mushroom with traditional coffee, an average consumer can ingest a sufficient quantity of maitake beta glucan to maintain good health via its immunopotentiating activity by enjoying two cups a day of maitake coffee.

Accordingly, one could replace their typical coffee with maitake coffee in their daily routine and avoid the need to supplement their usual diet in order to obtain the benefits of the maitake mushroom. Furthermore, the rich flavor and aroma of the maitake can enhance one's daily drinking pleasure.

The present invention provides such a maitake coffee via a roasting and brewing method that uses both dried maitake along with any desired coffee beans. Additionally, the present invention further provides a coffee based beverage that has reduced bitterness and reduces acid stomach commonly associated with coffee consumption.

### DETAILED DESCRIPTION OF THE PREFERRED EMBODIMENTS

The present invention is further described in the following embodiments.

In a first embodiment of the present invention, a method of producing a beverage is provided, the method comprising (a) combining roasted, ground maitake mushroom together with roasted, ground coffee beans to provide a maitake-coffee mixture, and (b) brewing the maitake-coffee mixture. In preferred embodiments, the method further comprises roasting of dried maitake mushroom, preferably whole dried maitake mushroom, followed by cooling the roasted maitake mushroom and grinding the cooled maitake mushroom, prior to the combining step (a).

Roasting Dried Maitake Mushroom

The dried maitake mushroom is preferably prepared in accordance with processes described in U.S. Pat. No. 6,616,928, the contents of which are hereby in corporated by reference. The roasting of the dried maitake mushroom is performed at a temperature and for a time period sufficient to cause at least partial breakdown of cellulosic materials and proteins (such as enzymes) in the maitake mushroom, to enable extraction of active components (such as beta glucan) during brewing with hot water. In roasting the maitake mushroom, it is desirable to obtain roasting of the interior of the mushroom without burning or charring of the exterior. The maximum roasting temperature is preferably less than 500° F. to avoid charring/burning of the exterior of the mushroom. The roasting time is preferably in a range of 10 to 20 minutes, beginning at a lower temperature and increasing temperature during the roasting period until the desired maximum temperature is reached. Preferably, the maximum temperature is from 350 to 415° F., more preferably from 390 to 415° F. In a most preferred embodiment, the roasting of the mushroom is performed for a period of approximately 15 minutes at a starting temperature of approximately 200° F., increasing to a final temperature of approximately 415° F. by the end of the 15 minutes. If the roasting temperature is below 350° F., the dried maitake mushroom is insufficiently broken down to provide effective brewing and extraction. If the roasting temperature is above 415° F., charring of the exterior starts to occur, which can result in taste problems in the final maitake-coffee mixture.

Cooling Roasted Maitake Mushroom

In order to provide better and easier grinding and handling, the roasted maitake mushroom is cooled after roasting and before grinding and mixing with coffee. After roasting and cooling, the maitake mushroom can be immediately mixed with the coffee or can be stored prior to mixing with the coffee. The roasted maitake mushroom is preferably cooled to a temperature less than 150° F., more preferably less than 100° F., most preferably to room temperature. The cooling can occur naturally or can be assisted with forced cool air or refrigeration if desired.

Grinding, Mixing Roasted Maitake with Coffee Beans

The grinding and mixing of the roasted and cooled maitake mushroom with coffee beans allows for the coffee oils to bond with the ground maitake mushroom. This is important for the brewing process because ground roasted maitake mushroom by itself tends to be hydrophobic, and thus very difficult to extract with hot water. By mixing the ground maitake mushroom with the ground coffee, the bonding of the coffee oils with the ground maitake mushroom permits the brewing water to filter through and extract both the coffee and maitake mushroom more efficiently.

Furthermore, the grinding is preferably performed such that the average size of ground maitake mushroom particles is no larger than 0.06125 in ( 1/16^{th} inch), preferably from 0.025-0.06125 in, most preferably about 0.03125 in, in order to provide the best blending of the coffee and maitake mushroom.

Any type/roast of coffee beans can be used in the present method, including, but not limited to, French Roast, dark roast, Sumatran, Columbian, etc, as well as flavored coffees if desired, such as hazelnut, French vanilla, etc.

There is no particular limitation as to how the grinding and/or mixing is performed.

Brewing Roasted Maitake Coffee Mixture

After preparation of the maitake mushroom-coffee mixture, the mixture is then brewed. There is no particular limitation as to how the brewing is performed, and can be performed using any home or institutional coffee brewing equipment, including, but not limited to, French press, American drip machines, espresso machines, etc.

In another embodiment of the present invention, a beverage obtained from the above-described process is provided.

In a further embodiment of the present invention, a beverage comprising a brewed mixture of roasted coffee and roasted maitake mushroom is provided.

In the present invention, the combination of ground dried maitake mushroom with traditional coffee allows an average consumer to ingest a sufficient quantity of maitake beta gulcan to maintain good health via the immunopotentiating activity by enjoying two cups a day of maitake coffee. Preferably, two cups of maitake coffee is approximately equal to one ounce of fresh (raw) maitake mushroom which is believed to be of sufficient quantity to maintain good health.

Furthermore, as the average consumer can replace their typical coffee with maitake coffee in their daily routine without sacrificing the desired benefits of the coffee, they can avoid the need to supplement their usual diet in order to obtain the benefits of the maitake mushroom. In addition, the rich flavor and aroma of the maitake can enhance the consumer's daily drinking pleasure.

The present inventors have also surprisingly found that such a maitake coffee has reduced bitterness and reduces acid stomach, two detriments commonly associated with the consumption of coffee alone.

Accordingly, the present invention provides a coffee based beverage with all of the benefits associated with maitake mushrooms, all of the benefits associated with coffee, but without the bitterness and acid stomach related to coffee, and without the need for consuming additional food/drink throughout the day in order to obtain the benefits as is the case with maitake extracts, teas and meals.

Obviously, numerous modifications and variations of the present invention are possible in light of the above teachings. It is therefore to be understood that within the scope of the appended claims, the invention may be practiced otherwise than as specifically described herein.

1. A method of producing a beverage comprising:
combining roasted, ground maitake mushroom with roasted, ground coffee beans to provide a maitake-coffee mixture, and
brewing the maitake-coffee mixture.

2. The method according to claim 1, further comprising, prior to the combining step, roasting of dried maitake mushroom for a time period and at a temperature sufficient to at least partially break down cellulosic components and protein components of the dried maitake mushroom to enable extracting through brewing.

3. The method according to claim 2, wherein the dried maitake mushroom is roasted for a time period of 10-20 minutes at temperatures up to a maximum of from 350-415° F.

4. The method according to claim 3, wherein the dried maitake mushroom is roasted for a time period of 10-20 minutes at temperatures up to a maximum of from 390-415° F.

5. The method according to claim 4, wherein the dried maitake mushroom is roasted for a time period of approximately 15 minutes beginning at a temperature of approximately 200° F., increasing to a temperature of 415° F. at the end of the 15 minutes.

6. The method according to claim 2, further comprising cooling the roasted dried maitake mushroom to a temperature of 150° F. or less, prior to the combining step.

7. The method according to claim 6, wherein the cooling is performed to a temperature of 100° F. or less.

8. The method according to claim 7, wherein the cooling is performed to a temperature of room temperature.

9. The method according to claim 6, further comprising grinding the cooled roasted dried maitake mushroom prior to the combining step.

10. The method according to claim 9, wherein the grinding is performed such that the average size of ground maitake mushroom particles is no larger than 0.06125 in.

11. The method according to claim 10, wherein the grinding is performed such that the average size of ground maitake mushroom particles is approximately 0.03125.

12. A beverage produced by the method according to claim 1.

13. A beverage comprising a brewed liquid from brewing of a mixture of roasted, ground coffee and roasted, ground maitake mushroom.
